(19) United States
(12) Patent Application Publication
(10) Pub. No.: US 2025/0214019 A1
(43) Pub. Date: Jul. 3, 2025

(54) GAS FILTER SYSTEM

(71) Applicant: MANN+HUMMEL GmbH, Ludwigsburg (DE)

(72) Inventors: Pascal NEEF, Trossingen (DE); Christoph WITTMERS, Bietigheim-Bissingen (DE); Andreas WEBER, Freiberg (DE); Dennis STARK, Mauer (DE); Mario RIEGER, Ludwigsburg (DE); Markus HANSELMANN, Lauffen (DE); Peter PEKNY, Neuenmarkt (DE); Eva HALLBAUER, Himmelkron (DE); Daniel SCHMID, Sachsenheim (DE); Steffen GERLACH, Nufringen (DE); Friedrich KUPFER, Marklkofen (DE); Philipp HETTKAMP, Steinheim (DE); Johannes GRAD, Simbach (DE); Pedro Miguel PEREIRA MADEIRA, Bietigheim-Bissingen (DE); Dieter WEISS, Gefrees (DE)

(21) Appl. No.: 19/082,345

(22) Filed: Mar. 18, 2025

Related U.S. Application Data
(63) Continuation of application No. PCT/EP2023/066664, filed on Jun. 20, 2023.

(30) Foreign Application Priority Data
Sep. 20, 2022 (EP) 22196482.8

(51) Int. Cl. B01D 46/24; B01D 46/64

(52) U.S. Cl. CPC B01D 46/2414; B01D 46/64; B01D 2271/027

(57) ABSTRACT

A gas filter system including an outer filter element having a first filter medium arranged between a first end cap and a second end cap, and an inner filter element having a second filter medium arranged between a third end cap and a fourth end cap, wherein the first filter medium is arrangeable to surround the second filter medium, wherein the first, third and fourth end caps are open, wherein the outer filter element is closed at the second end cap, wherein the outer filter element has an axial protrusion at the second end cap that protrudes into the inner filter element and exhibits a radially outward facing sealing surface, and wherein the fourth end cap of the inner filter element has a second sealing section for sealing abutment against the sealing surface of the protrusion.

### CROSS-REFERENCE TO RELATED APPLICATIONS

This application is a continuation application of International Application No. PCT/EP2023/066664 having an international filing date of Jun. 20, 2023, and designating the United States, the international application claiming a priority date of Sep. 20, 2022, based on prior filed European patent Application No. EP 22 196 482.8, the entire entire contents of the aforesaid international application and the aforesaid European patent application being incorporated herein by reference.

### TECHNICAL FIELD

The present invention refers to a gas filter system including an outer filter element having a first filter medium arranged between a first end cap and a second end cap, and an inner filter element having a second filter medium arranged between a third end cap and a fourth end cap, wherein the first filter medium is arrangeable to surround the second filter medium.

### BACKGROUND

Such a filter system is known from DE 10 2018 215 603 A1.

In some applications, it is required to filter a gas flow with two filter elements. Typically, the gas flows through a first filter element and then, the prefiltered gas flows through a second filter element. The filter elements may be arranged in a common housing. This kind of filter system is for instance used to filter combustion air for large combustion engines, such as for trucks, construction vehicles or the like. Another application is the filtration of air for fuel cells.

DE 10 2018 215 603 A1 discloses a gas filter system with a first filter element which surrounds a second filter element. At a first axial end, open end caps of the two filter elements are associated with an outlet for clean air. At a second axial end, the first (outer) filter element has an open end cap and the second (inner) filter element has a closed end cap. The closed end cap of the second (inner) filter element is arranged to close the opening in the end cap of the first (outer) filter element at the second axial end.

It is an object of the invention to provide a gas filter system with improved sealing between two filter elements, which are adapted for joint use.

This is achieved by a gas filter system according to the invention and use of two filter elements according to the invention. Advantageous embodiments of the invention are given in the following description and accompanying drawings.

### SUMMARY

In accordance with the invention, a gas filter system is provided. The gas filter system includes an outer filter element having a first filter medium arranged between a first end cap and a second end cap, and an inner filter element having a second filter medium arranged between a third end cap and a fourth end cap.

The first filter medium is arrangeable to surround the second filter medium. The filter media may be hollow-cylindrical or conical, for example with an essentially circular or oval cross section. The filter media each surround a longitudinal axis. For example, the filter media may be arranged concentric to a common longitudinal axis. Indications of directions such as radial or axial refer to the longitudinal axis. In principle, the first and third end caps are associated with a first axial end; the second and fourth end caps are associated with a second axial end.

During use of the gas filter system, a gas flow is typically first directed through the first filter medium of the outer filter element and then through the second filter medium of the inner filter element.

According to the invention, the first, third and fourth end caps are open. The first, third and fourth end caps generally have a central opening.

The outer filter element is closed at the second end cap. The second end cap may be a monolithic closed end cap. Alternatively, a closing means may be permanently affixed to the outer filter element for sealing of the second end cap.

According to the invention, the outer filter element has an axial protrusion at the second end cap, which protrusion protrudes into the inner filter element, when the filter elements are arranged for filtering operation of the gas filter system. The protrusion provides guidance between the filter elements, for example, during mounting. The protrusion typically protrudes beyond the fourth end cap of the inner filter element in the axial direction.

Further, according to the invention, the protrusion exhibits a radially outward facing sealing surface. In other words, a radially outward facing sealing surface is formed on the protrusion.

The fourth end cap of the inner filter element has a second sealing section for sealing abutment against the sealing surface of the protrusion. In this way, the two filter elements are sealed against each other at the second axial end. Since the second end cap of the outer filter element, which covers the inner filter element is closed, the filter elements, including the inner filter element, are also sealed towards an environment, such as an inlet side of the filter system.

The second sealing section may be an integral part of the fourth end cap. Typically, the second sealing section is made of a material, which is softer than the material of the protrusion. For example, the sealing section or the fourth end cap in total may be made from polyurethane, for example polyurethane foam. The protrusion may be made from rigid plastic.

In general, sealing sections described within the context of this invention are softer than the counterpart against which they seal. For example, a respective sealing section may be made from polyurethane, for example polyurethane foam. The respective counterpart may be made from rigid plastic.

The protrusion may be integrally formed with a support tube of the outer filter element. In other words, the support tube closes the second end cap and forms the protrusion. The support tube stiffens the outer filter element. The support tube may be partially embedded in the second end cap.

The second end cap may have at least one support leg for axial support of the outer filter element against a housing. The support leg may be integrally formed with the second end cap.

The first end cap of the outer filter element may have a first sealing section for sealing abutment against a housing, for example in the axial direction. Alternatively, or additionally, the first sealing section may provide radial sealing abutment against the housing.

The third end cap of the inner filter element may have a third sealing section for sealing abutment against a housing, for example in the radial direction. Alternatively, or additionally, the third sealing section may provide axial sealing abutment against the housing.

The first end cap of the outer filter element and the third end cap of the inner filter element are sealed against each other. Gas flow between the filter elements from an environment such as an inlet side, or into the environment from between the filter elements is thereby prevented. This ensures that the gas flows through the two filter elements consecutively.

The first end cap may have a fourth sealing section for sealing abutment against the third end cap, for example in the radial direction.

Alternatively, the third end cap may have a fourth sealing section for sealing abutment against the first end cap, for example in the radial direction.

The gas filter system further includes a housing, in which the inner and outer filter elements are arrangeable. In a mounted state, the filter elements are arranged inside the housing. Typically, the housing includes a first housing part associated with the first axial end and a second housing part associated with the second axial end. An inlet may be formed at the first or second housing part. An outlet may be formed at the first housing part. The outlet may be in fluid communication with a clean side inside the inner filter element.

The housing may have a central tube, which extends into the inner filter element at the third end cap in a mounted state of the filter system. The central tube provides guidance to the inner filter element and support to the second filter medium.

The central tube may be held at an axial collar of the housing. This is advantageous for manufacturing the housing. A snap fit may be provided between the collar and the central tube.

The third end cap may be sealed against the collar or the central tube. For example, the third sealing section of the third end cap may sealingly abut the collar or the central tube. In this way, the inside of the inner filter element may be conveniently sealed towards the housing.

It may be provided, that the protrusion and the central tube overlap each other in the axial direction. Mutual guidance and support between the central tube and the outer filter element may be achieved in this way. This may also facilitate mounting of the filter system. For example, the protrusion may engage into the central tube. In other words, the central tube may surround the protrusion radially outwardly.

The housing has a dome, which protrudes into the protrusion at the second end cap. The dome may provide guidance during mounting and may provide additional support to the outer filter element during use of the filter system.

It may further be provided, that the dome and the central tube overlap each other in the axial direction. Undesired movement of the filter elements during operation may be effectively reduced with this design. Upon heavy vibration, the central tube may bear against the dome via the protrusion, which is arranged between the central tube and the dome.

The first or the second filter medium, for example the second filter medium of the inner filter element, may have gas-adsorbing properties and may contain activated carbon. Typical harmful gases are SO₂, NOₓ and NH₃.

The first or the second filter medium, for example the first filter medium of the outer filter element, may be made with cellulose.

The first and/or the second filter medium may be pleated.

The invention also relates to the use of an outer filter element and/or an inner filter element in a gas filter system according to the invention, as described above. The gas filter system may be used for cathode air filtration of a fuel cell in an electric vehicle.

### BRIEF DESCRIPTION OF DRAWINGS

Other advantages and features of the invention will be appreciated from the following description of exemplary embodiments of the invention with reference to the drawing figures, which show various details. The individual features, as described above or explained below, may each be implemented individually or implemented together in any useful combination in variants of the invention.

FIG. 1 shows a first embodiment of a gas filter system according to the invention, the gas filter system comprising an outer filter element, an inner filter element and a housing, in a schematic sectional view.

FIG. 2 shows the outer filter element of the gas filter system of FIG. 1, in a schematic sectional view.

FIG. 3 shows the inner filter element of the gas filter system of FIG. 1, in a schematic sectional view.

FIG. 4 shows a first end of the filter system of FIG. 1 in an enlarged view.

FIG. 5 shows a second end of the filter system of FIG. 1 in an enlarged view.

FIG. 6 shows a first end of a second embodiment of a filter system according to the invention in a schematic sectional view.

FIG. 7 shows a first end of a third embodiment of a filter system according to the invention in a schematic sectional view.

### DETAILED DESCRIPTION

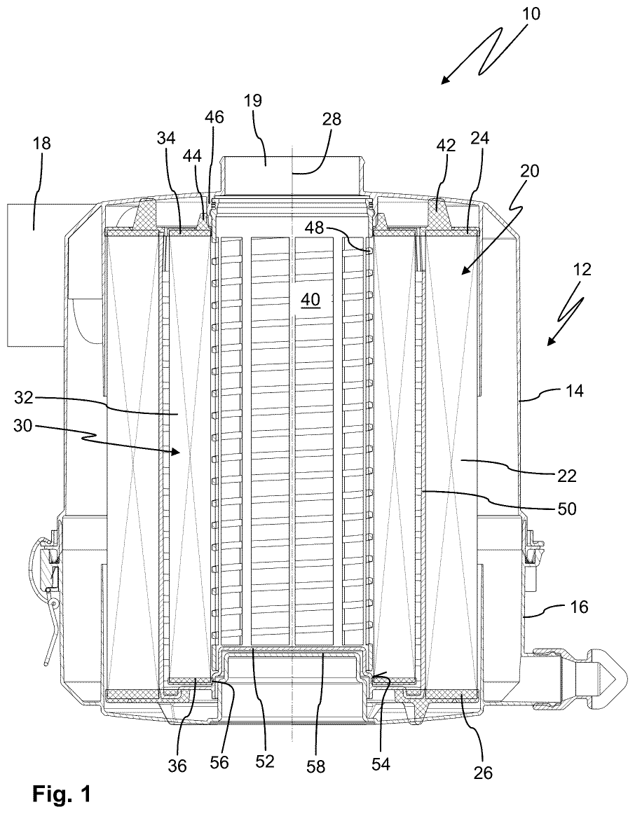

FIG. 1 shows a gas filter system 10. The filter system 10 comprises a housing 12. The housing 12 has a first housing part 14 and a second housing part 16, which are attachable to each other. An inlet 18 allows gas to enter the housing 12. Here the inlet 18 is formed at the first housing part 14. An outlet 19 for filtered gas is also formed at the first housing part 14. The housing parts 14, 16 may be made from metal and/or rigid plastic.

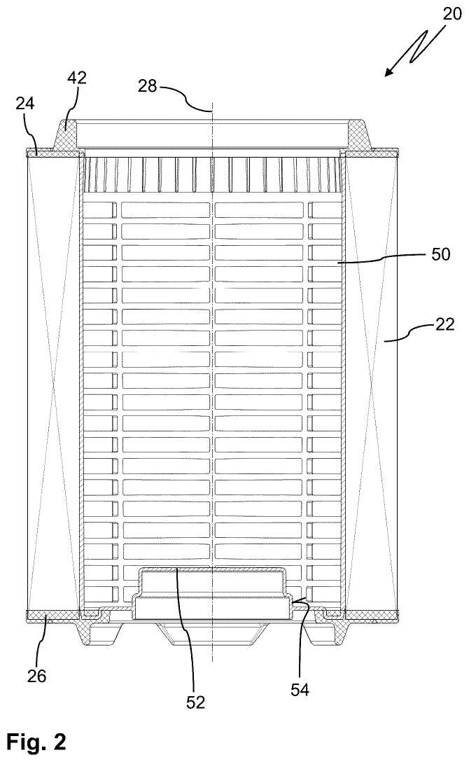

The filter system 10 further comprises an outer filter element 20, see also FIG. 2. The outer filter element 20 comprises a first filter medium 22. The first filter medium 22 is contained between a first end cap 24 and a second end cap 26. The first filter medium 22 surrounds a longitudinal axis 28 in a circular manner. The first filter medium 22 may be made from pleated cellulose paper.

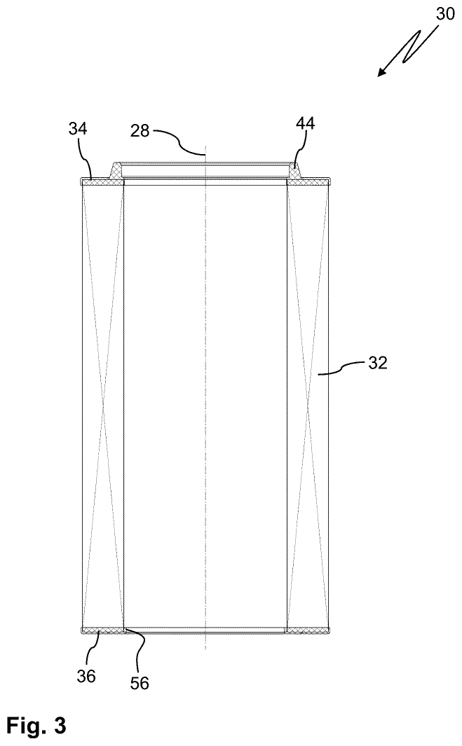

The filter system 10 further comprises an inner filter element 30, see also FIG. 3. The inner filter element 30 comprises a second filter medium 32. The second filter medium 32 is contained between a third end cap 34 and a fourth end cap 36. The second filter medium 32 also surrounds the longitudinal axis 28 in a circular manner. The second filter medium 32 may contain activated carbon in order to achieve gas-adsorbing properties.

The inner filter element 30 is arranged inside the outer filter element 20. Both filter elements 20, 30 are arranged inside the housing 12. Here, the first and second filter medium 22, 32 are concentric to one another and to the longitudinal axis 28.

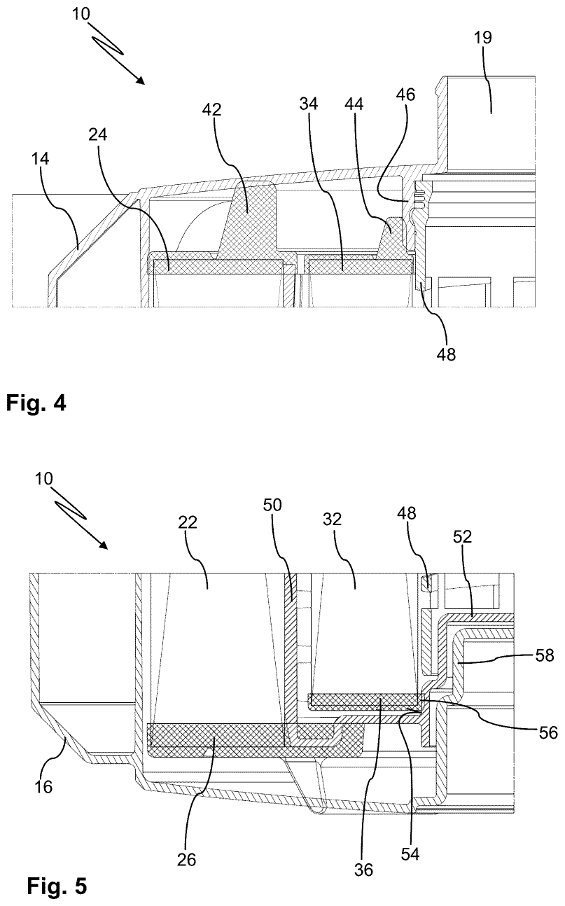

At a first axial end of the filter system 10, the first end cap 24 is arranged to surround the third end cap 34, see also FIG. 4. The first end cap 24 and the third end cap 34 each have a central opening, see also FIG. 2 and FIG. 3, respectively. The outlet 19 is in fluid communication with a clean side 40 within the inner filter element 30, cf. FIG. 1.

A first sealing section 42 axially protrudes form the first end cap 24. The first sealing section 42 sealingly abuts the first housing part 14 in the axial direction. Here, the first end cap 24 with the first sealing section 42 is integrally made from polyurethane foam.

A third sealing section 44 axially protrudes from the third end cap 34. The third sealing section 44 sealingly abuts the first housing part 14 in the radial direction. For example, the third sealing section 44 sealingly rests against a collar 46, which axially protrudes into the housing 12 at the outlet 19. Here, the third end cap 34 and the third sealing section 44 are integrally made from polyurethane foam.

A central tube 48 of the housing 12 is held at the axial collar 46. The central tube 48 extends through the opening of the third end cap 34 towards the fourth end cap 36. The central tube 48 may be made from rigid plastic.

The outer filter element 20 comprises a support tube 50. The support tube 50 extends from the first end cap 24 to the second end cap 26 on the inside of the first filter medium 22. The support tube 50 may be partially embedded in the first and/or second end cap 24, 26. The support tube 50 may be made from rigid plastic.

At the second axial end, the support tube 50 sealingly closes the outer filter element 20. At the second end cap 26, the support tube 50 forms a closed protrusion 52, see also FIG. 5. The protrusion 52 extends into the clean side of the inner filter element 30 through a central opening in the fourth end cap 36 of the inner filter element 30.

The fourth end cap 36 is sealed against the protrusion 52. At the protrusion 52, a sealing surface 54, which faces radially outwardly is formed. A second sealing section 56 is formed at the opening of the fourth end cap 36. Here, the fourth end cap 36 and the second sealing section 56 are integrally made from polyurethane foam. The second sealing section 56 sealingly abuts the sealing surface 54 of the protrusion 52 in the radial direction.

The central tube 48 of the housing 12 and the protrusion 52 of the outer filter element 20 overlap each other along the longitudinal axis 28. The protrusion 52 may be tapered above the sealing surface 54 in order to extend into the central tube 48.

The housing 12 may have a dome 58. Here, the dome 58 is formed at the second housing part 16. The dome 58 extends towards the inside of the inner filter element 30. For example, the dome 58 extends into the protrusion 52 of the outer filter element 20. More particularly, the dome 58 and the central tube 48 overlap each other along the longitudinal axis 28.

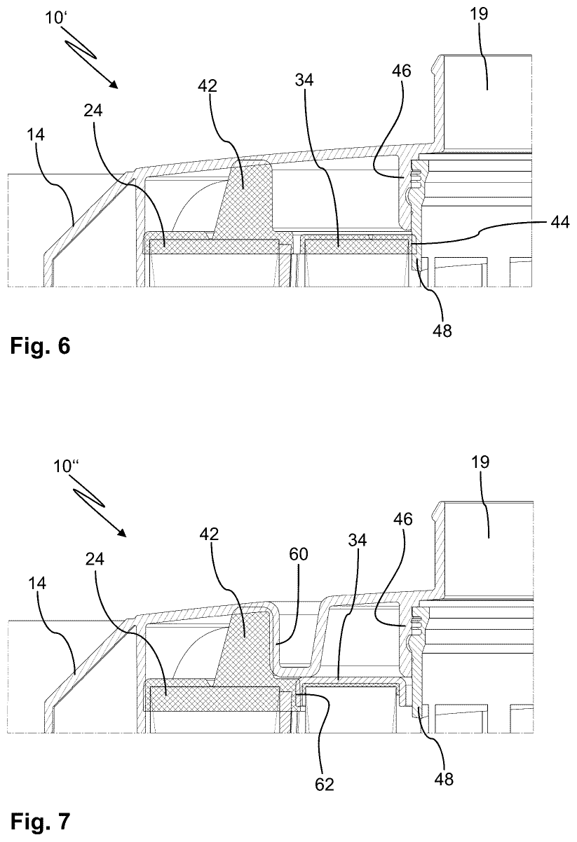

A second embodiment of the gas filter system 10′, which is partially depicted in FIG. 6, corresponds substantially to the first embodiment of the gas filter system 10, cf. FIGS. 1-5 and the description above. The filter system 10′ differs from the gas filter system 10 in that, in the second embodiment, the third endcap 34 is sealed against the central tube 48. The third sealing section 44 sealingly abuts the central tube 48 in the radial direction, here slightly below the collar 46.

A third embodiment of the gas filter system 10″, which is partially depicted in FIG. 7, is also substantially identical to the first embodiment of the gas filter system 10, cf. FIGS. 1-3.

In the third embodiment, the first end cap 24 of the outer filter element 20 is axially and radially sealed against the housing 12. The first housing part 14 has a circumferential rib 60, against which the first sealing section 42 of the first end cap 24 rests in the radial direction.

The first end cap 24 of the outer filter element 20 and the third end cap 34 of the inner filter element 30 are sealed against each other. The first end cap 24 also has a fourth sealing section 62. The first end cap 24 with the first sealing section 42, as well as the fourth sealing section 62, are integrally made from polyurethane foam. The third end cap 34 is made from rigid plastic and glued to the second filter medium 32. The fourth sealing section 62 sealingly abuts the third end cap 34 in the radial direction.

### REFERENCE NUMBERS

Gas filter system 10; 10′; 10″
Housing 12
First housing part 14
Second housing part 16
Inlet 18
Outlet 19
Outer filter element 20
First filter medium 22
First end cap 24
Second end cap 26
Longitudinal axis 28
Inner filter element 30
Second filter medium 32
Third end cap 34
Fourth end cap 36
Clean side 40
First sealing section 42
Third sealing section 44
Collar 46
Central tube 48
Support tube 50
Protrusion 52
Sealing surface 54
Second sealing section 56
Dome 58
Rib 60
Fourth sealing section 62

1. A gas filter system comprising:
an outer filter element having a first filter medium arranged between a first end cap and a second end cap; and
an inner filter element having a second filter medium arranged between a third end cap and a fourth end cap;
the first filter medium being arrangeable to surround the second filter medium;
wherein the first, third and fourth end caps are open;
wherein the outer filter element is closed at the second end cap;
wherein the outer filter element has an axial protrusion at the second end cap that protrudes into the inner filter element and exhibits a radially outward facing sealing surface; and
wherein the fourth end cap of the inner filter element has a second sealing section for sealing abutment against the sealing surface of the protrusion.

2. The gas filter system according to claim 1, wherein the protrusion is integrally formed with a support tube of the outer filter element.

3. The gas filter system according to claim 1, wherein the first end cap of the outer filter element has a first sealing section for sealing abutment against a housing in an axial direction.

4. The gas filter system according to claim 1, wherein the third end cap has a third sealing section for sealing abutment against a housing in a radial direction.

5. The gas filter system according claim 1, wherein the first end cap of the outer filter element and the third end cap of the inner filter element are sealed against each other.

6. The gas filter system according to claim 5, wherein the first end cap has a fourth sealing section for sealing abutment against the third end cap in a radial direction.

7. The gas filter system according to claim 5, wherein the third end cap has a fourth sealing section for sealing abutment against the first end cap in a radial direction.

8. A gas filter system according to claim 1, further comprising a housing, wherein the outer filter element and the inner filter element are arrangeable within the housing.

9. The gas filter system according to claim 8, wherein the housing has a central tube that extends into the inner filter element at the third end cap.

10. The gas filter system according to claim 9, wherein the central tube is held at an axial collar of the housing.

11. The gas filter system according to claim 10, wherein the third end cap is sealed against the collar or the central tube of the housing.

12. The gas filter system according to claim 9, wherein the protrusion and the central tube overlap each other in an axial direction.

13. The gas filter system according to claim 8, wherein the housing has a dome that protrudes into the protrusion at the second end cap.

14. The gas filter system according to claim 9, wherein the dome and the central tube overlap each other in an axial direction.

15. The gas filter system according to claim 1, wherein the first filter medium of the outer filter element or the second filter medium of the inner filter element has gas-adsorbing properties.

16. The gas filter system according to claim 1, wherein the first filter medium of the outer filter element or the second filter medium of the inner filter element is made with cellulose.

17. Use of the outer filter element and/or the inner filter element in the gas filter system according to claim 1.
